(19) United States
(12) Patent Application Publication
(10) Pub. No.: US 2016/0041011 A1
(43) Pub. Date: Feb. 11, 2016

(54) STEPPER MOTOR WITH ELECTROMAGNETIC ARRANGEMENTS

(71) Applicant: Continental Automotive Systems, Inc., Auburn Hills, MI (US)

(72) Inventor: Hiram Aburto Crespo, Tlaquepaque (MX)

(21) Appl. No.: 14/455,124

(22) Filed: Aug. 8, 2014

(51) Int. Cl. G01D 13/02; H02K 41/03; H02P 6/00; G01D 13/22

(52) U.S. Cl. CPC G01D 13/02; G01D 13/22; H02K 41/031; H02P 6/006

(57) ABSTRACT

An instrument cluster assembly with electromagnetic arrangements is disclosed and includes at least one gauge. The gauge includes a dial having a linear slot and a pointer assembly disposed in the slot. A linear motor configured to move the pointer assembly. A controller generates a signal to the linear motor in response to a vehicle operating condition to move the pointer assembly.

### BACKGROUND

The present disclosure is related generally to instrument clusters for vehicles.

Vehicles include instrument clusters and gauges for communicating desired operating parameters such as vehicle speed, engine rpm and direction indicators. Different methods and devices are known for communicating this information. Each method and device provides not only the function of communicating operating information to a driver, but also form and contribute to the style and aesthetic appearance of a vehicle interior. Accordingly, it is desirable to develop new and unique devices and methods for communicating and representing vehicle operating information to contribute to a desired appearance.

### SUMMARY

An instrument cluster assembly with electromagnetic arrangements is disclosed and includes at least one gauge. The gauge includes a dial having a slot and a pointer assembly disposed in the slot. The pointer assembly moves linearly via a linear motor. A controller is configured to generate a signal in response to a vehicle operating condition to move the pointer assembly.

One example linear motor includes a plurality of permanent magnets arranged at the dial. The pointer assembly includes a drive coil configured to interact with the plurality of permanent magnets to move the pointer assembly to indicate on dial graphics on the dial.

In one application, the controller generates the signal to a driver that drives the coils with currents. The position of the pointer assembly is thus controlled by the current driven through the coils by the driver after receiving a signal from the controller. The pointer assembly is moved to indicate on dial graphics associated with the vehicle operating condition. The coil may be a three phase coil creating current vectors in the direction of the pointer motion.

These and other features disclosed herein can be best understood from the following specification and drawings, the following of which is a brief description.

### BRIEF DESCRIPTION OF THE DRAWINGS

FIG. 1 is a front view of an example instrument cluster assembly.

FIG. 2 is a front view of the example gauge.

FIG. 3 is a schematic view of the example gauge.

FIG. 4 is a schematic view of the electromagnetic principles used in the example gauge.

FIG. 5 is a schematic view of one permanent magnet arrangement.

FIG. 6 is a schematic view of a second example linear motor.

FIG. 7 is a schematic view of a second example gauge.

### DETAILED DESCRIPTION

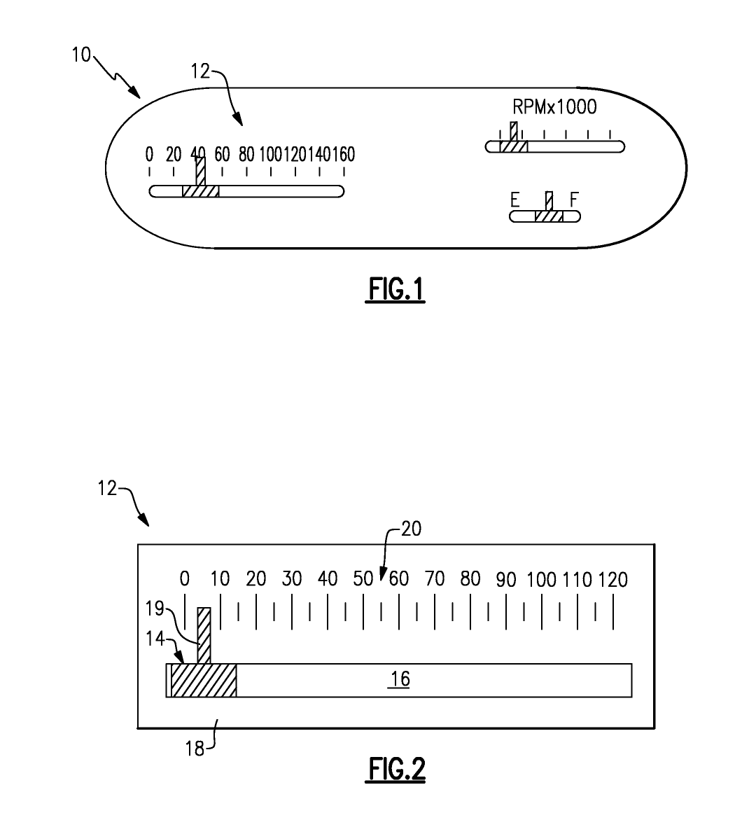

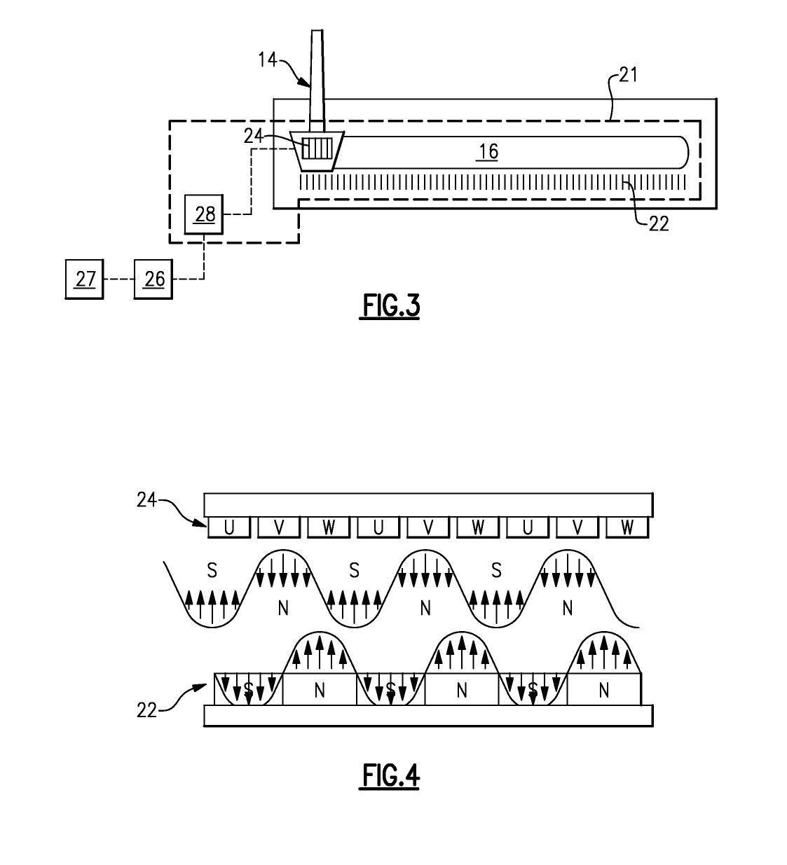

Referring to FIGS. 1 and 2, an example instrument cluster assembly 10 includes at least one gauge 12. The example gauge 12 includes a pointer assembly 14 received in a slot 16 in a dial 18. The example slot 16 is linear and horizontal, and the pointer assembly 14 is configured to move horizontally along the slot 16 and includes a needle 19 configured to indicate on dial graphics 20 on the dial 18. Other slot orientations and directions of movement, such as vertical, may be utilized with the features described herein.

The example dial graphics 20 are above the slot 16 and extend parallel with the slot 16. The example dial graphics 20 indicate speed, but other measurements indicated in instrument clusters may be used as well. Alternatively, the dial graphics 20 may be disposed below the slot 16.

The example gauge 12 utilizes a linear motor arrangement 21 to drive the pointer assembly 14. In the example linear motor arrangement 21, electromagnetic components move the pointer assembly 14 to a desired position. As shown schematically in FIG. 3, the example linear motor 21 includes a plurality of permanent magnets 22 adjacent the slot 16. The magnets 22 are aligned below the slot 16 parallel to the direction of the movement of the pointer assembly 14. The magnets 22 are disposed behind the dial 18. In one embodiment, the magnets 22 are disposed on a light housing along the path which the pointer will follow.

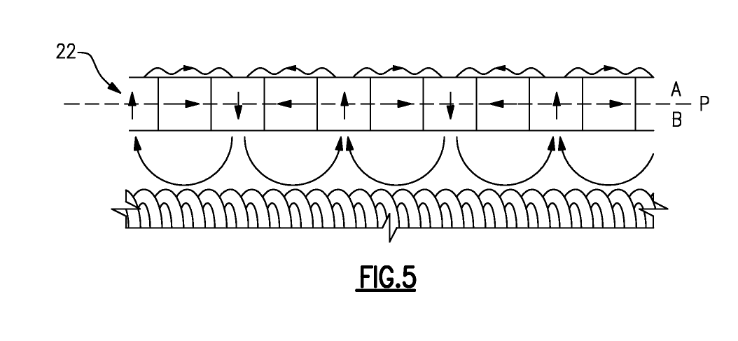

In the example linear motor 21, the pointer assembly 14 further comprises an electromagnetic drive coil arrangement 24 configured to interact with the permanent magnets 22. In one example, the coil 24 is encapsulated substantially within the interior of the pointer assembly 14. As shown in FIG. 4, the coils 24 of the pointer assembly 14 are grouped into three phases (U, V, W) to create current vectors traveling in the direction of the pointer travel motion. Interaction between traveling current vectors and the magnetic fields from permanent magnets 22 produces drive force for moving the pointer assembly 14 in the desired direction.

To move the pointer assembly 14, a controller 26 receives information indicative of a vehicle operating condition from a sensor 27 associated with the vehicle operating condition. Example vehicle operating conditions include speed, RPMs, fuel level, and various temperatures. Additional conditions are contemplated. The controller 26 then generates a signal in response to the received vehicle operating condition information to move the pointer assembly 14. The controller 26 thus translates the information received into a command to move the pointer assembly 14. The example controller 26 generates the signal to a driver 28 of linear motor 21 that drives the three phases of coils 24 with three interrelated sets of sinusoidal drive currents. The position of the pointer assembly 14 is thus controlled by the current driven through the coils 24 by the driver 28 after receiving a signal from the controller 26. The pointer assembly 14 is moved to indicate on dial graphics 20 that are associated with the vehicle operating condition.

In one application, as shown in FIG. 5, the permanent magnets 22 are arranged in a Halbach array. The orientation of each individual magnet is rotated 90 degrees from the orientation of the magnet adjacent to it. The effect is that the magnetic flux will cancel on one side (side A) of the plane P and will reinforce itself on the other side (side B) of the plane P. In this application, side B would be the side closest to the pointer assembly 14. Thus, only one side of the permanent magnet arrangement 22 would have a magnetic field. The opposite side would not have one and would thus not interfere with other components in the instrument cluster, such as additional electromagnetic gauges. The magnets aligned with the direction of motion will provide pull or push to the coil. The magnets normal to the motion will provide levitation or stabilization to the coil.

The example gauge 12 thus allows for a linear gauge without the complicated gear system that would be required if the gauge were mechanical, giving a designer additional options when designing an aesthetically pleasing instrument cluster.

The disclosed linear motor is exemplary. Other linear motor arrangements are contemplated.

A second example linear motor 121 is shown in FIG. 6 and includes two electromagnets 140, 142 and a permanent magnet 144 therebetween to form the forcer 146. The forcer 146 further comprises four sets of teeth 148 to align with the teeth of platen 150, which is fixed and has no permanent magnet. An attraction force is created between the forcer 146 and the platen 150. A gap 152 is maintained therebetween.

The electromagnets 140, 142 comprise field windings 152, 154. When current is generated in a field winding 152, 154, the resulting magnetic field will reinforce magnetic flux at one pole face and cancel magnetic flux at the other. The face receiving highest flux will align its teeth with the platen 150. Thus, selectively applying current to the field windings 152 and 154 can concentrate flux at any of the four poles 154, allowing movement of the forcer in the desired direction.

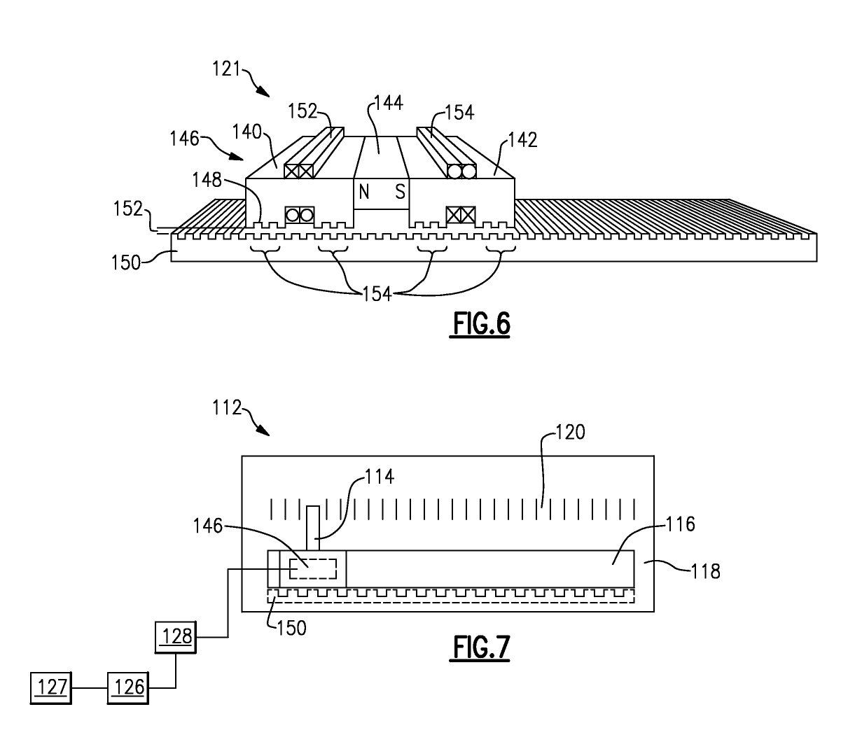

FIG. 7 shows the implementation of linear motor 121 into gauge 112. The pointer assembly 114 includes forcer 146 and is disposed within the slot 116 in the dial 118 and configured to move linearly to indicate on dial graphics 120. The platen 150 is disposed behind the dial 118 and below the slot 116 and configured to interact with the forcer 146 within the pointer assembly 114. In one example, the forcer 146 is substantially within the pointer assembly 114, and the body of pointer assembly 114 maintains the desired air gap 152 between forcer 146 and platen 150. Other means, such as roller bearings or air bearings, are contemplated.

A controller 126 receives information indicative of a vehicle operating condition from a sensor 127 associated with the vehicle operating condition. The controller 126 then generates a signal in response to the received vehicle operating condition information to move the pointer assembly 114. The controller 126 thus translates the information received into a command to move the pointer assembly 114. The example controller 126 generates the signal to a driver 128 of linear motor 121 that drives the field windings 152 and 154. The pointer assembly 114 is moved to indicate on dial graphics 120 that are associated with the vehicle operating condition.

Although the different examples have a specific component shown in the illustrations, embodiments of this disclosure are not limited to those particular combinations. It is possible to use some of the components or features from one of the examples in combination with features or components from another one of the examples.

Although embodiments of this invention have been disclosed, a worker of ordinary skill in this art would recognize that certain modifications would come within the scope of this invention. For that reason, the following claims should be studied to determine the true scope and content of this invention.

We claim:

1. An instrument cluster assembly comprising:
at least one gauge comprising:
a dial including a linear slot;
a pointer assembly disposed in said slot;
a linear motor configured to move said pointer assembly; and
a controller configured to generate a signal to said linear motor in response to a vehicle operating condition to move said pointer assembly.

2. The instrument cluster assembly of claim 1, wherein said linear motor comprises:
a plurality of permanent magnets arranged at said dial; and
a drive coil included in said pointer assembly and configured to interact with said plurality of permanent magnets to move said pointer assembly to indicate on dial graphics on said dial.

3. The instrument cluster assembly of claim 2, wherein said drive coil is encapsulated substantially within said pointer assembly.

4. The instrument cluster assembly as recited in claim 2, wherein said drive coil is a three phase coil.

5. The instrument cluster assembly as recited in claim 2, wherein said permanent magnets are disposed parallel with said slot.

6. The instrument cluster assembly as recited in claim 1, wherein said pointer is configured to move horizontally.

7. The instrument cluster assembly as recited in claim 1, wherein said pointer is configured to move vertically.

8. The instrument cluster assembly as recited in claim 2, wherein said linear motor comprises a driver configured to drive said coil with current, said controller configured to generate said signal to said driver.

9. The instrument cluster assembly as recited in claim 1, wherein said controller is configured to receive information from a sensor associated with said vehicle operating condition.

10. The instrument cluster assembly as recited in claim 9, wherein said vehicle operating condition is speed.

11. A gauge assembly comprising:
a dial including a linear slot;
a pointer assembly disposed in said slot and configured to indicate on dial graphics on said dial;
a linear motor configured to move said pointer assembly; and
a controller configured to generate a signal to said linear motor in response to a vehicle operating condition to move said pointer assembly.

12. The gauge assembly as recited in claim 11, wherein said linear motor comprises:
a plurality of permanent magnets arranged at said dial; and
a drive coil included in said pointer assembly and configured to interact with said plurality of permanent magnets to move said pointer assembly

13. The gauge assembly as recited in claim 12, wherein said drive coil is a three phase coil.

14. The gauge assembly as recited in claim 12, wherein said permanent magnets are disposed parallel with said slot.

15. The gauge assembly as recited in claim 11, wherein said pointer is configured to move horizontally.

16. The gauge assembly as recited in claim 12, said linear motor comprising a driver configured to drive said coil with current, said controller configured to generate said signal to said driver.

17. The gauge assembly as recited in claim 11, wherein said controller is configured to receive information from a sensor associated with said vehicle operating condition.

18. The gauge assembly as recited in claim 17, wherein said vehicle operating condition is speed.

19. A method for assembling a gauge comprising:
providing a dial;
providing a pointer assembly configured to indicate on said dial;
providing a linear motor to move said pointer assembly; and
providing a controller configured to generate a signal to move said pointer assembly in response to a vehicle operating condition.

20. The method as recited in claim 19, further comprising:
connecting a driver to said controller and linear motor, said driver configured to receive said signal from said controller and to provide current to said linear motor to move said pointer assembly.
